(19) United States
(12) Patent Application Publication
(10) Pub. No.: US 2026/0269741 A1
(43) Pub. Date: Sep. 10, 2026

(54) POWER CONVERSION DEVICE

(71) Applicant: Mitsubishi Electric Corporation, Tokyo (JP)

(72) Inventors: Yoshiaki ISHIGURO, Tokyo (JP); Satoshi MURAKAMI, Tokyo (JP); Ryota KONDO, Tokyo (JP); Akira NAKAGAWA, Tokyo (JP); Yoshihiro TAKESHIMA, Tokyo (JP)

(73) Assignee: Mitsubishi Electric Corporation, Tokyo (JP)

(21) Appl. No.: 18/993,602

(22) PCT Filed: Jul. 25, 2022
(86) PCT No.: PCT/JP2022/028570

§ 371 Date: Jan. 13, 2025

(51) Int. Cl. H02M 7/483; H02M 1/00; H02M 7/5395

(52) U.S. Cl. CPC H02M 7/483; H02M 1/0054; H02M 7/5395

(57) ABSTRACT

This power conversion device includes: a capacitor series circuit; an inverter circuit in which legs including switching elements connected in series are connected in parallel; and a switch circuit including switching elements, and having one end connected to a connection point of the capacitor series circuit and other ends connected to connection points of the switching elements of the inverter circuit. The inverter circuit is capable of performing 2-level operation by turning off the switching elements of the switch circuit, and performing 3-level operation by turning on/off the switching elements of the switch circuit. For performing switchover of an operation level between 2-level operation and 3-level operation, a control circuit changes switching speeds of the switching elements.

### TECHNICAL FIELD

The present disclosure relates to a power conversion device.

### BACKGROUND ART

One of conventional power conversion devices includes first and second DC power supplies connected in series and a power converter which converts DC power of each DC power supply to AC power, the power converter is configured such that at least two switching elements formed of semiconductor elements are connected in series to form one arm, at least three of such arms are connected in parallel, an AC switch having at least two switching elements connected in series and each formed of a semiconductor element and a diode connected in antiparallel to the semiconductor element is connected between a mutual connection point of the switching elements in each arm and a mutual connection point of the DC power supplies, and each AC switch is turned on or off, whereby the power converter can perform 3-level operation or 2-level operation (see Patent Document 1 below).

### CITATION LIST

### Patent Document

Patent Document 1: WO2012/025978

### SUMMARY OF THE INVENTION

### Problem to be Solved by the Invention

In the power conversion device as described above, in 2-level operation, power supply voltage is applied to the switching elements connected in series, and in 3-level operation, voltage that is half the power supply voltage is applied to the switching elements connected in series. Here, in a state in which a gate resistance value for turn-off is optimally adjusted in a range where surge voltage occurring in switching is not greater than allowable surge voltage of the switching elements so as to reduce loss in 3-level operation, if the operation is switched to 2-level operation, voltage applied to the switching elements connected in series is doubled as compared to that in 3-level operation. As a result, surge voltage occurring in switching might exceed the allowable surge voltage of the switching elements, thus causing a risk that the switching elements fail.

The present disclosure has been made to solve the above problem, and an object of the present disclosure is to provide a power conversion device capable of performing switchover of the operation level between 2-level operation and 3-level operation without having a risk of causing failure of switching elements even in switchover of the operation level.

### Means to Solve the Problem

A power conversion device according to the present disclosure includes: a capacitor series circuit including a plurality of capacitors connected in series, and having both ends connected to both ends of a DC voltage source; an inverter circuit in which a plurality of legs each including a plurality of switching elements connected in series are connected in parallel, and of which DC input ends are connected to both ends of the capacitor series circuit and AC output ends are connected to a load; a switch circuit including a plurality of switching elements, and having one end connected to a connection point between the plurality of capacitors, and other ends connected to a plurality of connection points between the switching elements of the inverter circuit; and a control circuit which controls the inverter circuit and the switch circuit. The inverter circuit is capable of performing 2-level operation by turning off the switching elements included in the switch circuit, and capable of performing 3-level operation by turning on/off the switching elements included in the switch circuit. In a case of performing switchover of an operation level between the 2-level operation and the 3-level operation, the control circuit changes switching speeds of the switching elements of the inverter circuit and the switch circuit.

### Effect of the Invention

The power conversion device according to the present disclosure makes it possible to provide a power conversion device having no risk of causing failure of switching elements even in switchover of the operation level.

### BRIEF DESCRIPTION OF THE DRAWINGS

FIG. 1 is a configuration diagram showing a power conversion device according to embodiment 1.

FIG. 2 is a configuration diagram showing a gate input unit of the power conversion device according to embodiment 1.

FIG. 3 shows load current and switching voltage in 2-level operation and 3-level operation.

FIG. 4 schematically shows the details of loss in the power conversion device in 2-level operation and 3-level operation.

FIG. 5 shows time-series data of a WLTC mode traveling pattern.

FIG. 6 schematically shows the relationship between a current value for level operation switchover and loss in WLTC mode traveling.

FIG. 7 schematically shows the relationship between a current value for level operation switchover and the volume of the power conversion device.

FIG. 8 is an operation concept diagram showing features of control in the power conversion device according to embodiment 1.

FIG. 9 is a specific control flowchart in the power conversion device according to embodiment 1.

FIG. 10 is a specific control flowchart in the power conversion device according to embodiment 1.

FIG. 11 is a specific control flowchart in the power conversion device according to embodiment 1.

FIG. 12 schematically shows switchover of the operation level in accordance with a motor operation point in embodiment 1, where the relationship between a carrier frequency, and 2-level operation and 3-level operation, is mapped on rotational speed and torque characteristics of a motor.

FIG. 13 shows a configuration of the power conversion device according to embodiment 1, different from that in FIG. 1.

FIG. 14 is an operation concept diagram showing features of control in a power conversion device according to embodiment 2.

FIG. 15 shows a configuration of a buffer circuit of the gate input unit of the power conversion device according to embodiment 1.

FIG. 16 shows a hardware configuration of a control circuit of the power conversion device according to each of embodiments 1 and 2.

### DESCRIPTION OF EMBODIMENTS

### Embodiment 1

A power conversion device according to embodiment 1 of the present disclosure will be described with reference to the drawings.

### [Configuration of Power Conversion Device]

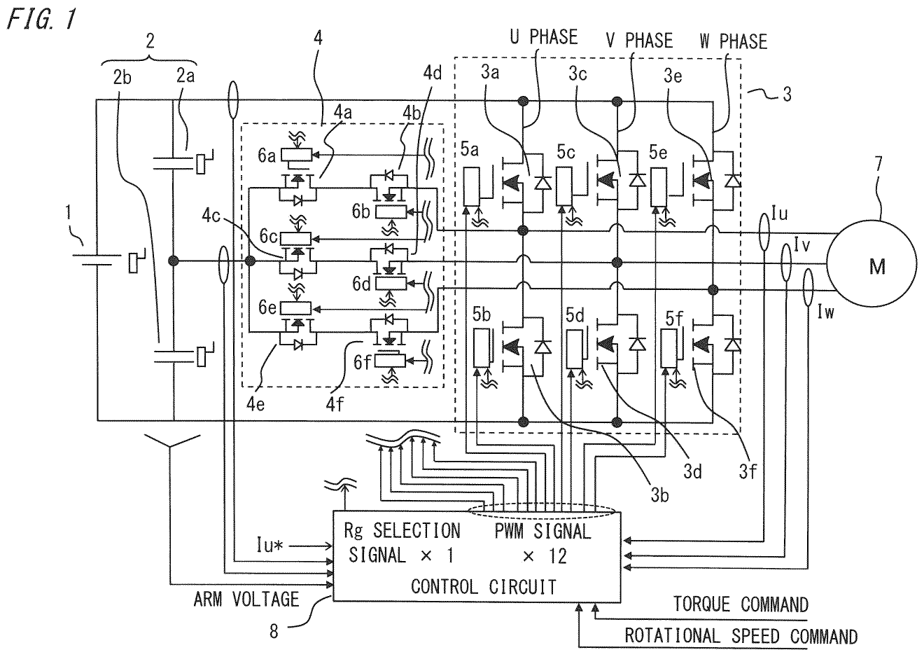

FIG. 1 is a configuration diagram showing the power conversion device according to embodiment 1.

The power conversion device shown in FIG. 1 is connected between a DC voltage source 1 and a motor 7 as a load. The power conversion device converts DC power from the DC voltage source 1 to AC power and outputs the AC power to the motor (load) 7, thereby operating the motor (load) 7.

The power conversion device includes a capacitor series circuit 2 in which a plurality of capacitors 2a, 2b are connected in series, an inverter circuit 3 having a plurality of switching elements 3a, 3b, 3c, 3d, 3e, 3f, a switch circuit 4 having a plurality of switching elements 4a, 4b, 4c, 4d, 4e, 4f, gate input units 5a, 5b, 5c, 5d, 5e, 5f for the switching elements 3a, 3b, 3c, 3d, 3e, 3f, gate input units 6a, 6b, 6c, 6d, 6e, 6f for the switching elements 4a, 4b, 4c, 4d, 4e, 4f, and a control circuit 8 which controls the inverter circuit 3 and the switch circuit 4.

In the present embodiment, a three-phase inverter device is shown as an example of the power conversion device. However, the power conversion device may not necessarily be a three-phase inverter device, and may be an inverter device. for a single phase or four or more phases. In addition, although the motor 7 is shown as an example of a load, another load device may be applied.

The capacitor 2a and the capacitor 2b are connected in series, to form the capacitor series circuit 2. Here, a connection point between the capacitor 2a and the capacitor 2b is defined as a first connection point. Both ends of the capacitor series circuit 2 are connected to both ends of the DC voltage source 1 and DC input ends of the inverter circuit 3 described later. Although the case where the capacitor series circuit 2 is formed by two capacitors connected in series is shown here, the capacitor series circuit 2 is not limited thereto and may be formed by three or more capacitors that are connected.

The inverter circuit 3 has a configuration in which three legs each formed of two switching elements connected in series are connected in parallel, and both ends of each leg are connected to both ends of the capacitor series circuit 2 and both ends of the DC voltage source 1. In the example shown in FIG. 1, an arm of the switching element 3a and an arm of the switching element 3b are connected in series, to form a leg for U phase, an arm of the switching element 3c and an arm of the switching element 3d are connected in series, to form a leg for V phase, and an arm of the switching element 3e and an arm of the switching element 3f are connected in series, to form a leg for W phase. Here, connection points between the switching elements 3a and 3b, between the switching elements 3c and 3d, and between the switching elements 3e and 3f, are defined as second, third, and fourth connection points, respectively. The second, third, and fourth connection points serve as AC output ends of the inverter circuit 3. The motor 7 as a load is connected to the second, third, and fourth connection points, and the inverter circuit 3 supplies AC power to the motor 7 via the second, third, and fourth connection points.

As the switching elements 3a to 3f used in the inverter circuit 3, a metal oxide semiconductor field effect transistor (MOSFET) having an antiparallel diode between the source and the drain is used. The MOSFET may be made of SiC or Si, and the antiparallel diode may be a diode provided in the MOSFET or a diode externally provided. Alternatively, an element such as a gallium nitride-high mobility transistor (GaN-HEMT) or an insulated gate bipolar transistor (IGBT) to which a diode is connected in antiparallel, may be used.

The switch circuit 4 includes a plurality of switching elements 4a to 4f, and 2-level operation and 3-level operation described later can be switched through control of the switching elements 4a to 4f. The switch circuit 4 shown in FIG. 1 is provided between the second to fourth connection points of the inverter circuit 3 and the first connection point of the capacitors 2a, 2b, and is formed using metal oxide semiconductor field effect transistors (MOSFETs) each having an antiparallel diode between the source and the drain. Also here, the MOSFET may be made of SiC or Si, and the antiparallel diode may be a diode provided in the MOSFET or a diode externally provided. Alternatively, an element such as a gallium nitride-high mobility transistor (GaN-HEMT) or an insulated gate bipolar transistor (IGBT) to which a diode is connected in antiparallel, may be used.

In the switch circuit 4, the switching element 4a and the switching element 4b, the switching element 4c and the switching element 4d, and the switching element 4e and the switching element 4f, are connected in series in opposite directions. Source terminals of the switching elements 4a, 4c, 4e are connected to the first connection point of the capacitor series circuit 2, and source terminals of the switching elements 4b, 4d, 4f are respectively connected to the second to fourth connection points. In the configuration of opposite direction series connection, the switching elements 4a and 4b, the switching elements 4c and 4d, and the switching elements 4e and 4f, are connected via their drain terminals.

In the configuration of the switch circuit 4 as described above, when the switching element 4a is turned on, current can flow from the second connection point to the first connection point, and when the switching element 4b is turned on, current can flow from the first connection point to the second connection point. In addition, when the switching element 4c is turned on, current can flow from the third connection point to the first connection point, and when the switching element 4d is turned on, current can flow from the first connection point to the third connection point. Further, when the switching element 4e is turned on, current can flow from the fourth connection point to the first connection point, and when the switching element 4f is turned on, current can flow from the first connection point to the fourth connection point. The switch circuit 4 is not limited to the configuration shown in FIG. 1, and may have any configuration as long as the current flowing direction can be controlled through turning on or off of either switching element.

The gate input units 5a to 5f turn on/off the respective switching elements 3a to 3f of the inverter circuit 3 on the basis of pulse width modulation (PWM) signals outputted from the control circuit 8, and set a gate resistance value Rgoff for turn-off of the switching elements 3a to 3f of the inverter circuit 3 on the basis of a gate resistance selection signal (Rg selection signal).

The gate input units 6a to 6f turn on/off the respective switching elements 4a to 4f of the switch circuit 4 on the basis of PWM signals outputted from the control circuit 8, and set a gate resistance value Rgoff for turn-off of the switching elements 4a to 4f of the switch circuit 4 on the basis of a gate resist nice selection signal (Rg selection signal).

### [Gate Input Units of Power Conversion Device]

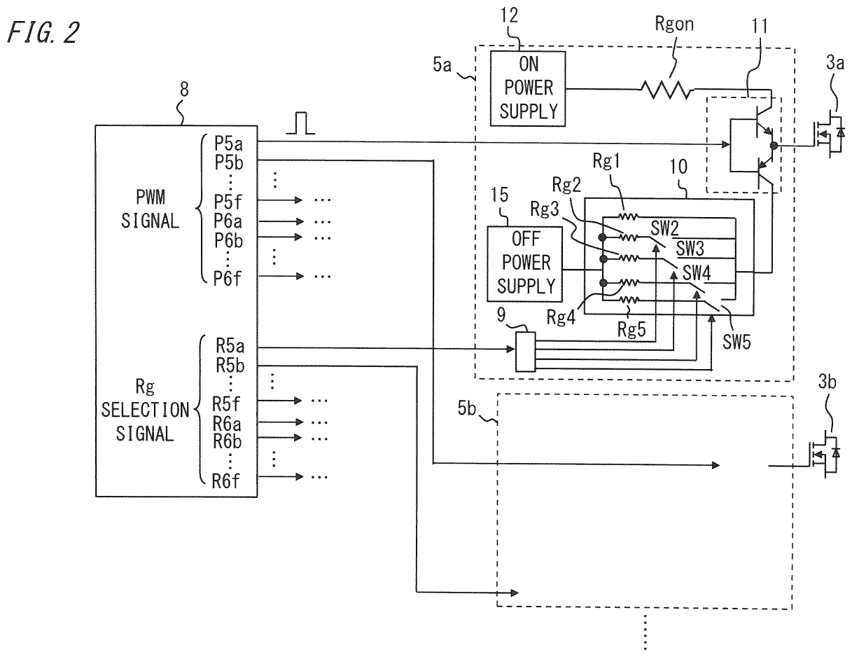

FIG. 2 is a configuration diagram showing each gate input unit of the power conversion device according to embodiment 1. In FIG. 2, in particular, a configuration diagram focusing on the connection relationship between the control circuit 8 and the gate input unit 5a corresponding to the switching element 3a is shown.

As shown in FIG. 2, a PWM signal P5a outputted from the control circuit 8 to the gate input unit 5a is inputted to a totem-pole-type buffer circuit 11 composed of a PNP transistor and an NPN transistor, for example. Then, in a case where the PWM signal P5a is ON, current flows from an ON power supply 12 through a gate resistor Rgon for turn-on and then the buffer circuit 11 to the switching element 3a, so that the switching element 3a is turned on. On the other hand, in a case where the PWM signal P5a is OFF, current flows from the switching element 3a to an OFF power supply 15 through a gate resistance switchover circuit 10 with the gate resistance value Rgoff for turn-off, so that the switching element 3a is turned off. Thus, ON/OFF operation of the switching element 3a is performed.

Also, PWM signals P5b, P5c, P5d, P5e, P5f and PWM signals P6a, P6b, P6c, P6d, P6e, P6f outputted from the control circuit 8 to the gate input units Sb to 5f and the gate input units 4a to 4f work in the same manner as described above, thus performing ON/OFF operations of the switching element 3b to 3f and the switching elements 4a to 4f.

An Rg selection signal R5a outputted from the control circuit 8 performs switchover operation for switches SW2, SW3, SW4, SW5 in order to adjust the gate resistance value Rgoff of the gate resistance switchover circuit 10. That is, the Rg selection signal R5a is a signal indicating, in a time-division manner, whether to turn on or off each of the switches SW2, SW3, SW4, SW5, and when the signal is inputted to a gate resistance determination unit 9, the gate resistance determination unit 9 divides the signal into signals for turning on or off the switches SW2 to SW5 and inputs these signals to the switches SW2 to SWS, thereby performing ON/OFF operations for the switches SW2 to SW5 by an arbitrary combination. Then, the gate resistance switchover circuit 10 adjusts the gate resistance value Rgoff for turn-off of the switching element 3a to a combined resistance value of resistance values of a resistor Rg1 and resistors Rg2, Rg3, Rg4, Rg5 when they are turned on.

In FIG. 1, as shown by “Rg SELECTION SIGNAL×1”, Rg selection signals R5a, R5b, R5c, R5d, R5e, R5f, R6a, R6b, R6c, R6d, R6e, R6f are assumed to be one kind (common), for simplification of control. Here, since only voltage (Vdc/2) that is half the voltage (Vdc) of the DC voltage source 1 is applied to the switching elements 4a to 4f, maximum surge voltage is low as compared to that in the switching elements 3a to 3f, and in order to utilize a margin of the surge voltage for loss reduction, it is conceivable that gate resistance values for turn-off in the gate input units 6a to 6f for the switching elements 4a to 4f are set to be smaller than gate resistance values for turn-off in the gate input units 5a to 5f for the switching elements 3a to 3f. In this case, specifically, in FIG. 2, with respect to the common Rg selection signals R5a to R5f and R6a to R6f transmitted to the gate input units 5a to 5f and the gate input units 6a to 6f, the resistance values of the resistors Rg1 to Rg5 of the gate input units 5a to 5fand the resistors Rg1 to Rg5 of the gate input units 6a to 6f are changed, thereby realizing the above setting.

### [Power Conversion Device and Motor]

The motor 7 is connected to the AC output ends of the inverter circuit 3 and operates with AC power outputted from the inverter circuit 3. The motor 7 may be any type. In FIG. 1, a control device (not shown) calculates a torque command and a rotational speed command, and the control circuit 8 controls the switching elements 3a to 3f and the switching elements 4a to 4f of the power conversion device on the basis of the torque command and the rotational speed command, thereby performing drive control for the motor 7. The control circuit 8 may serve also as the control device for generating the torque command and the rotational speed command.

The control circuit 8 controls the switching elements 3a to 3f of the inverter circuit 3 and the switching elements 4a to 4f of the switch circuit 4. That is, the control circuit 8 controls AC power to be outputted to the motor 7, on the basis of operation state information about the power conversion device including the inverter circuit 3 and the switch circuit 4, operation state information about the motor 7, and command value information for the power conversion device and the motor 7. For example, the control circuit 8 acquires voltage of the DC voltage source 1, voltages and currents of the capacitors 2a, 2b, and temperatures of the inverter circuit 3 and the switch circuit 4, and acquires phase currents of the motor 7, rotational position information, and torque command-rotational speed command information (NT characteristics), from the motor 7. On the basis of the above information, the control circuit 8 controls the inverter circuit 3 and the switch circuit 4. In addition, in accordance with operation state information and command value information about the motor 7 or the power conversion device (inverter circuit 3, switch circuit 4) set in advance, the control circuit 8 appropriately sets a carrier frequency for the inverter circuit 3, an operation state which is 2-level operation or 3-level operation, and selection of the gate resistance value Rgoff in the gate resistance switchover circuit 10, by applying an operation map defined on the NT characteristics of the motor 7, for example. The details thereof will be described later.

### [2-Level Operation and 3-Level Operation of Power Conversion Device]

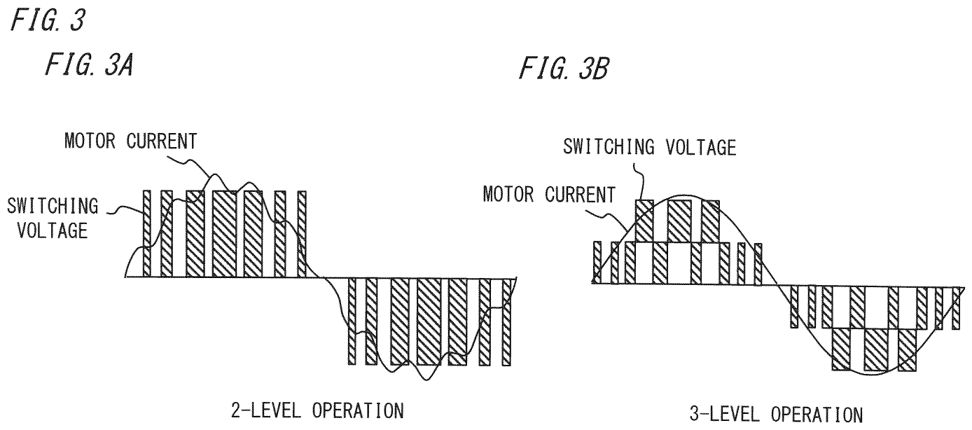

Here, with reference to FIG. 3A and FIG. 3B, 2-level operation and 3-level operation of the power conversion device will be described.

FIG. 3A and FIG. 3B schematically show motor current for one phase in a case of operating the power conversion device with 2 levels and in a case of operating the power conversion device with 3 levels.

First, 2-level operation will be described with reference to FIG. 3A. In the 2-level operation of the power conversion device described in the present embodiment, in FIG. 1, the switching elements 4a to 4f of the switch circuit 4 are turned off and the switching elements 3a to 3f of the inverter circuit 3 are turned on/off, whereby, in each phase, a positive voltage value and a negative voltage value of the total voltage of the capacitors 2a and 2b can be outputted to the motor 7. By controlling a time ratio of the positive voltage and the negative voltage, three-phase sinusoidal voltages can be supplied to the motor 7. The 2-level operation is general operation of a three-phase inverter device and the detailed description thereof is omitted.

Next, 3-level operation will be described with reference to FIG. 3B. Here, operation for one phase will be described. Operations for the other two phases are the same as that for the one phase and therefore the description thereof is omitted.

First, a state in which current flows from the power conversion device to the motor 7 will be described as an example. Description is started from a state in which the switching elements 3a, 3b and the switching elements 4a, 4b are off and current is flowing through the diode connected in antiparallel to the switching element 3b and is circulating to the motor 7 in FIG. 1. From this state, the switching element 4b is turned on while the switching elements 3a, 3b and the switching element 4a remain off, whereby current flows to the motor 7 through the switching element 4b and the diode connected in antiparallel to the switching element 4a by voltage of the capacitor 2b.

Next, while the switching element 4b remains on, the switching element 3a is turned on (the switching element 3b and the switching element 4a remain off). Then, since the switching element 4a blocks reverse current, current does not flow through the switching elements 4a, 4b, and current flowing through the motor 7 increases by voltage of the capacitors 2a and 2b connected in series.

On the other hand, in a case of decreasing current to the motor 7, operation is performed through a procedure opposite to the above procedure, i.e., while the switching element 4b remains on, the switching elements 3a, 3b and the switching element 4a are turned off and current flows to the motor 7 by voltage of the capacitor 2b, so that current decreases. Lastly, all the switching elements are turned off.

With the inverter circuit 3 and the switch circuit 4 operated as described above, voltage of each switching element becomes voltage of the capacitors 2a, 2b, i.e., voltage (Vdc/2) that is half the voltage of the DC voltage source 1. Thus, switching loss is reduced, and since voltage for controlling current is small, current distortion becomes small.

Next, a case where current flows from the motor 7 to the inverter circuit 3 will be described.

First, the switching element 4a is turned on, the switching element 3b is turned on, and the switching element 4b is turned off. Then, since the switching element 4a blocks reverse current, current does not flow through the capacitor 2b, and current from the motor 7 flows to the switching element 3b and circulates to the motor 7.

Next, when the switching element 3b is turned off (the switching element 3a and the switching element 4b remain off), current of the motor 7 flows to the capacitor 2b through the switching element 4a and the diode connected in antiparallel to the switching element 4b.

Next, when the switching element 4a is turned off, current of the motor 7 flows through the diode connected in antiparallel to the switching element 3a and then flows to the capacitors 2a and 2b. Thereafter, switching is performed through a procedure opposite to the above procedure, whereby operation is performed so as to reduce current of the motor 7. In the above example, operation for one phase has been described, but the same applies to the other phases except that phases are different.

In comparison between current waveforms of motor phase currents in 2-level operation shown in FIG. 3A and 3-level operation shown in FIG. 3B, the current waveform in 2-level operation is distorted as compared to the current waveform in 3-level operation. This is because, as voltage for generating current, voltage doubled as compared to that in 3-level operation is used in 2-level operation, to control the current. In 2-level operation, since current distortion increases, there is a disadvantage that harmonic iron loss of the motor increases. In addition, in 2-level operation, since voltage in switching is doubled, there is a disadvantage that switching loss in the inverter circuit 3 occurring in switching increases.

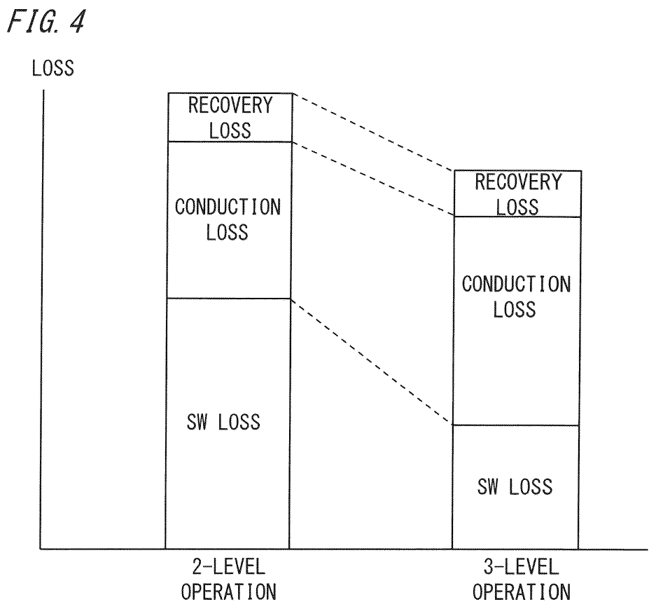

FIG. 4 schematically shows the details of loss in the power conversion device in 2-level operation and 3-level operation.

Here, in the switch circuit 4, the switching elements 4a and 4b connected in series, the switching elements 4c and 4d connected in series, and the switching elements 4e and 4f connected in series, are referred to as arms of the switch circuit 4.

Each arm (e.g., the arm of the switching elements 4a and 4b) of the switch circuit 4 is formed of two switching elements connected in series. Therefore, when current flows through the switch circuit 4, conduction loss in the switching element that is turned on (e.g., switching element 4a) and conduction loss in the diode connected in antiparallel to the other switching element (e.g., switching element 4b), occur. Thus, conduction loss in the power conversion device becomes greater in 3-level operation in which the switch circuit 4 is used. However, as described above, as compared to 2-level operation, in 3-level operation, voltage applied to the inverter circuit 3 is halved, so that switching loss and recovery loss are significantly reduced, resulting in reduction in total loss of the power conversion device.

Meanwhile, in the power conversion device capable of 3-level operation, addition of the switch circuit 4 and increase in the capacitor capacity (series connection of two capacitors 2a, 2b) are needed, so that the volume of the power conversion device increases.

Accordingly, in order to maximally reduce loss of the power conversion device while minimizing volume increase in the power conversion device capable of 3-level operation, 2-level operation and 3-level operation are switched in accordance with the current value of the power conversion device. That is, 3-level operation is used in a frequently used region not greater than a current threshold, and 2-level operation is used in a current region greater than the current threshold. Thus, since only current not greater than the prescribed current threshold flows through the switch circuit 4, the sizes of the switching elements 4a to 4f generally determined by the current amount are reduced, so that significant volume increase in the power conversion device can be suppressed.

In actuality, a loss amount in a case of application to an electric vehicle is expressed by fuel consumption in a worldwide-harmonized light vehicles test cycle (WLTC) mode (a mode in which traveling modes such as an urban mode, a suburban mode, and an expressway mode are distributed at an average usage time ratio) which is an international test method. In most of the times prescribed in the WLTC mode, a region in which torque is sufficiently smaller than performance limit torque of the motor is used. That is, in order to maximally reduce WLTC mode fuel consumption (loss) while minimizing volume increase in the power conversion device, level operation is switched so that 3-level operation is performed only within a current region which occupies most of the times prescribed in the WITC mode.

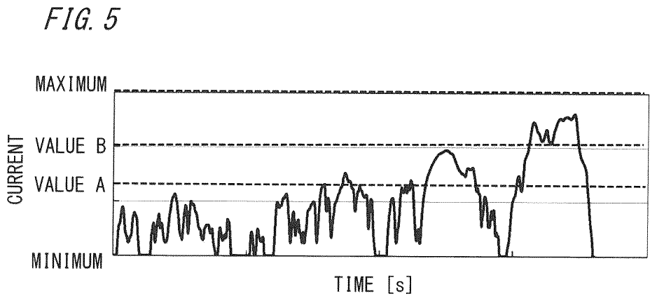

To describe specifically, FIG. 5 shows time-series data where the vertical axis of the WLTC mode traveling pattern is replaced with a current value for convenience sake and the horizontal axis indicates time. In FIG. 5, a minimum value, a value A, a value B, and a maximum value (minimum value<value A<value B<maximum value) are shown as current values for switching level operation.

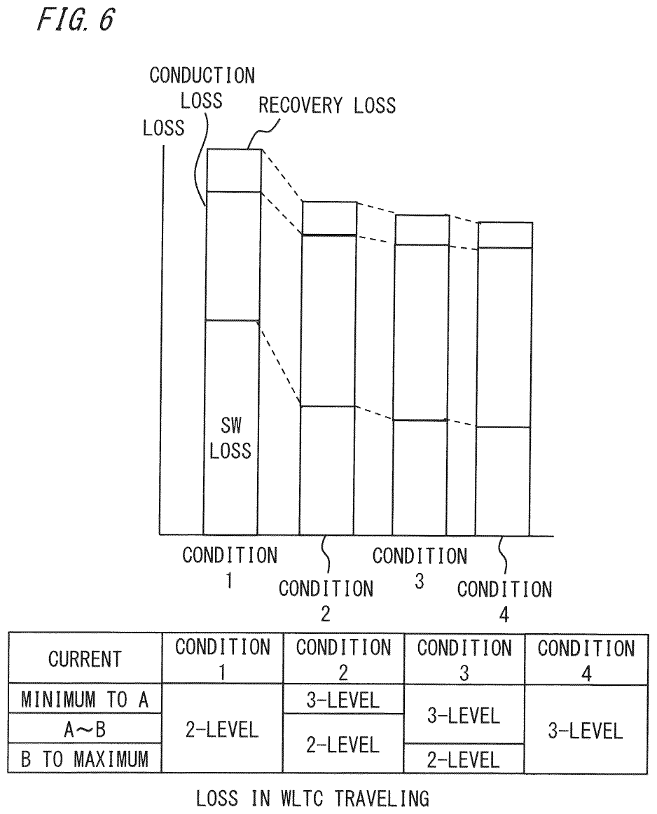

FIG. 6 shows an example of total loss when WLTC mode traveling has been completed while the current value for level operation switchover is changed as the entire region, the value A, and the value B in FIG. 5.

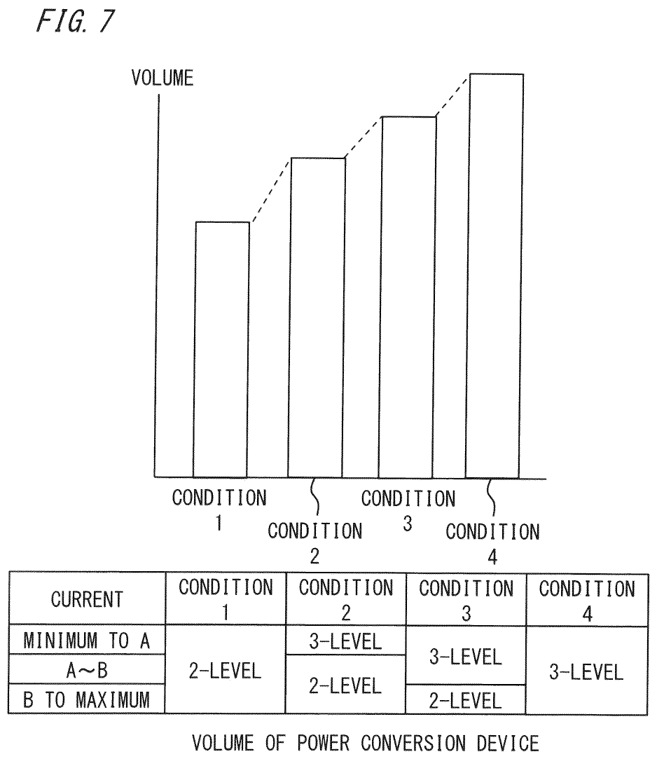

FIG. 7 shows an example in which the volume of the power conversion device is expressed while the current value for level operation switchover is changed as the entire region, the value A, and the value B in FIG. 5, as in FIG. 6.

In FIG. 6 and FIG. 7, a condition 1 is a case where 2-level operation is performed over the entire current region. In this condition, loss in the power conversion device shown in FIG. 6 is great, but since the switch circuit 4 is not needed, the volume of the power conversion device shown in FIG. 7 is small.

A condition 2 is a case where 3-level operation is performed in a region where current is 0 to the value A (the value A is the upper limit value of the current range that occupies most of the times in the WLTC mode traveling pattern, and is greater than 0) and 2-level operation is performed in a region in which current is not smaller than the value A. In this condition, as compared to the condition 1, 3-level operation is performed in most of the times, and therefore loss in the power conversion device shown in FIG. 6 is greatly reduced and the volume of the power conversion device shown in FIG. 7 increases due to addition of the switch circuit 4.

A condition 3 is a case where 3-level operation is performed in a region where current is 0 to the value B (A<B) and 2-level operation is performed in a region where current is not smaller than the value B. In this condition, a time during which 3-level operation is performed is not greatly different from that in the condition 2, and therefore loss in the power conversion device shown in FIG. 6 is slightly reduced as compared to the condition 2. Meanwhile, due to increase in the flowing current amount in the switch circuit 4, the size of the switch circuit 4 increases, so that the volume of the power conversion device shown in FIG. 7 increases.

The condition 4 is a case where 3-level operation is performed over the entire current region. In this condition, the effect of reducing loss in the power conversion device shown in FIG. 6 is greatest, but loss reduction as compared to the condition 2 is slight. Meanwhile, maximum current corresponding to the maximum torque of the motor 7 flows through the switch circuit 4. Therefore, the size of the switch circuit 4 increases, so that the volume of the power conversion device shown in FIG. 7 maximally increases.

As described above, considering the relationship between the amount of loss reduction in the power conversion device and the amount of volume increase in the power 5. conversion device, the current threshold for switchover of level operation is set at the value A as in the condition 2, for example. Alternatively, an upper limit current value (level switchover threshold) for 3-level operation may be determined in accordance with the volume of the switching elements of the switch circuit 4. The control circuit 8 performs switchover between the 2-level operation and the 3-level operation on the basis of the current value determined in advance as described above.

Since the ratio of switching loss, conduction loss, and recovery loss in loss (inverter loss) of the power conversion device changes in accordance with the rotational speed of the motor 7, switchover of the operation level may be determined in accordance with a motor operation point instead of the current value.

That is, from a torque command, a rotational speed command, and voltage of the DC voltage source, losses in the power conversion device and the motor in 2-level operation and 3-level operation, and the volume of the power conversion device, are calculated, whereby the threshold for operation level switchover is determined on a rotational speed-torque map (NT map) indicating the rotational speed and torque characteristics of the motor. The calculation method for loss may be any method. For example, a formula for calculating loss in the inverter circuit in each of 2-level operation and 3-level operation from a torque command or a rotational speed command (where the gate resistance value Rgoff for turn-off is selected so that surge voltage becomes equal between both level operations), may be used, of an operation table prepared in advance on the basis of actual measured data or the like may be used. In a case of calculating inverter loss, motor phase current, a modulation factor of switching of the inverter circuit 3, a carrier frequency, and a power factor are calculated from a torque command and a rotational speed command for the motor, and then inverter loss in each of 2-level operation and 3-level operation can be calculated from the above calculated values, switching loss (single pulse) data for each gate resistance value Rgoff for turn-off, and detected voltage of the DC voltage source.

Alternatively, the switch circuit 4 may be formed with a volume (size) corresponding to the maximum current in the motor specifications, and focusing on only loss reduction, the control circuit 8 may switch level operation so as to select, at each time, one of 2-level operation and 3-level operation that exhibits smaller total loss, on the basis of total loss in the inverter circuit 3 in each of 2-level operation and 3-level operation calculated as described above.

### [Change of Switching Speed of Power Conversion Device]

In the present embodiment, in addition to switchover of the operation level as described above, change of the switching speeds of the switching elements is performed, thus further reducing loss. Specifically, the gate resistance value Rgoff for turn-off of the switching element is switched, thereby reducing loss.

By adjusting the gate resistance value Rgoff for turn-off in a range where surge voltage occurring when the switching element is turned off does not exceed the withstand voltage of the switching element, the switching speed is increased, whereby switching loss can be reduced.

Normally, in a system in which an input/output operation condition (current, voltage, temperature, etc.) varies from time to time, a gate resistance value is adjusted so that surge voltage does not exceed allowable voltage in the worst condition in the operation range.

In the present embodiment, also in an environment in which an input/output operation condition varies, switchover of the gate resistance value for turn-off for minimizing loss is performed while surge voltage is monitored.

Specifically, in every fundamental cycle of AC output of the power conversion device, maximum surge voltage in the cycle is detected, and it is confirmed whether the maximum surge voltage is within a range (VY to VX) between an allowable surge upper limit voltage VY determined in consideration of design factors such as the switching element withstand voltage, variations, and voltage detection accuracy, and an allowable surge lower limit voltage VX set as a certain maximum surge voltage target range from the allowable surge upper limit voltage VY.

In a case where the maximum surge voltage is in the range between the allowable surge lower limit voltage VX and the allowable surge upper limit voltage VY, it is determined that an optimum gate resistance value Rgoff for turn-off has been selected, and the gate resistance value Rgoff for turn-off is not changed.

In a case where the maximum surge voltage is smaller than the allowable surge lower limit voltage VX, it is determined that there is room for further loss reduction, and thus the gate resistance value Rgoff for turn-off is set to be 1-stage smaller, i.e., the switching speed is set to be 1-stage faster.

In a case where the maximum surge voltage is not smaller than the allowable surge upper limit voltage VY, there is a risk that the switching element fails because the allowable surge upper limit voltage VY is exceeded. Therefore, the gate resistance value Rgoff for turn-off is set to be 1-stage greater, i.e., the switching speed is set to be 1-stage slower.

In order to more assuredly eliminate the risk of failure of the switching element, the gate resistance value Rgoff for turn-off may be set at a maximum value in a settable range instead of being 1-stage changed. In order to eliminate the risk faster, determination as to whether or not the maximum surge voltage is the allowable surge upper limit voltage VY or greater may be performed in a control loop having a shorter cycle, instead of every fundamental cycle of AC output.

Here, the setting of the gate resistance Rgoff for turn-off can be implemented by the circuit shown in FIG. 2 as described above. In addition, although it has been described that the gate resistance value Rgoff for turn-off is changed on a 1-stage basis, for example, if the maximum surge voltage is significantly smaller than the allowable surge lower limit voltage VX, the gate resistance value Rgoff for turn-off may be 2-stage or 3-stage changed in accordance with the separation width between both values. Further, the gate resistance value Rgoff for turn-off may be set by being calculated in consideration of switching element characteristics or a switching speed (di/dt) needed from the relationship of the input voltage or the load operation point.

Change of the switching speed for minimizing switching loss as described above may be implemented by change of gate voltage, change of a buffer capacity (current supply amount), or the like, instead of change of the gate resistance value Rgoff for turn-off.

For change of the gate voltage, the OFF power supply 15 shown in FIG. 2 is configured to allow change of the power supply voltage, and if surge voltage generated across the switching element or across a plurality of capacitors exhibits a margin with respect to the allowable surge voltage, the voltage of the OFF power supply 15 is changed to a higher voltage side. a method for change of the OFF power supply 15, desired power supply voltage may be selected by a switch from among a plurality of different power supply voltages that are prepared, on the basis of command information from the control circuit 8, for example.

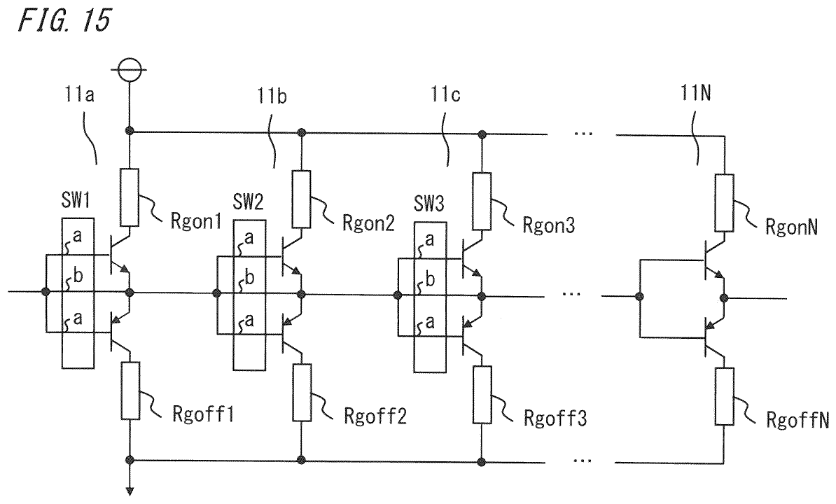

For change of the buffer capacity (current supply amount), for example, the buffer circuit 11 in FIG. 2 is configured to allow change of the number of stages thereof, and if surge voltage generated across the switching element or across a plurality of capacitors exhibits a margin with respect to the allowable surge voltage, the number of stages of the buffer circuit 11 is increased. For example, as shown in FIG. 15, the buffer circuit 11 is formed by a plurality of stages of buffer circuits 11a, 11 b, 11 c, . . . , 11N, and is configured such that a switch a or a switch b of each of switches SW1, SW2, SW3, . . . of the buffer circuits 11a, 11b, 11c, is turned on/off. Then, on the basis of command information from the control circuit 8, the switch a or the switch b described above is turned on/off, whereby the number of stages of the buffer circuit can be switched to a desired number. For example, in the case of FIG. 15, if the switch a. is turned off and the switch b is turned on for all the switches SW1, SW2, SW3, . . . , the buffer circuit 11N in one stage is selected. If the switch a is turned on and the switch b is turned off for all the switches SW1, SW2, SW3, the buffer circuits 11a, 11 b, 11 c, . . . , 11N in the maximum number of stages are selected.

Here, as a method for monitoring the maximum surge voltage in a cycle, for example, high-speed sampling and a sample and hold function by an A/D converter provided to a microcomputer may be used.

Alternatively, the maximum surge voltage may be obtained by charging a separately provided control capacitor with control voltage corresponding to voltage detected from the capacitors 2a, 2b in an analog manner (the control capacitor is discharged after being used for detection of the maximum surge voltage and selection determination for the gate resistance value Rgoff).

A determination timing for calculating the maximum surge voltage in one cycle may be determined on the basis of the phase of phase current or a current detection value.

Here, in a state in which the switching speed is increased (the gate resistance value Rgoff is set at a small value) until maximum surge voltage generated across the switching element falls within the range between the allowable surge lower limit voltage VX and the allowable surge upper limit voltage VY in order to minimize loss in 3-level operation, if the operation is switched to 2-level operation, voltage applied to the switching element is doubled. Thus, the maximum surge voltage generated across the switching element exceeds the allowable surge upper limit voltage VY, and therefore there is a risk that the switching element fails.

Accordingly, in the present embodiment, the gate resistance value for turn-off is changed to a great value before switchover from 3-level operation to 2-level operation, whereby surge voltage generated across the switching element is suppressed and thus failure of the switching element due to surge voltage is prevented, while loss in the power conversion device is minimized.

### [Control of Power Conversion Device]

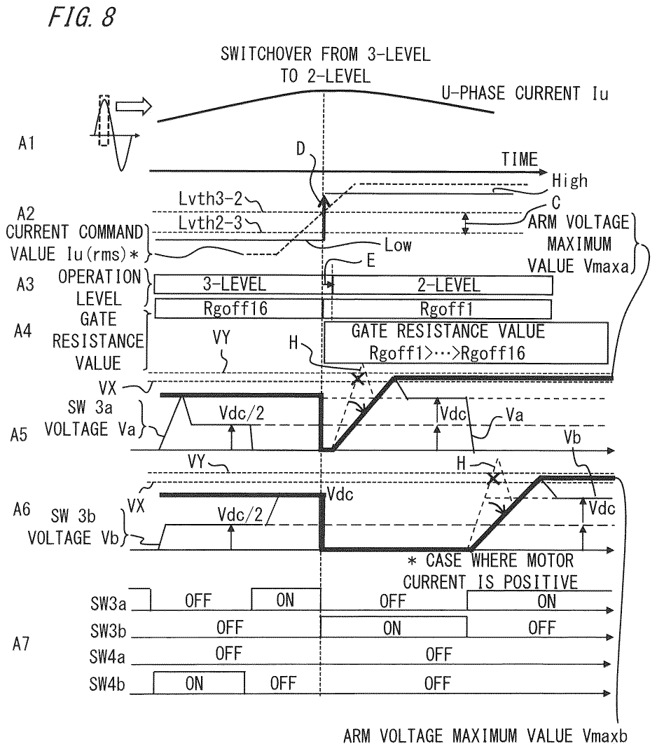

FIG. 8 is an operation concept diagram showing features of control in the power conversion device according to the present embodiment.

With reference to FIG. 8, operation for implementing switchover of the operation level of the power conversion device and switchover of the gate resistance value Rgoff for turn-off will be described.

In the present embodiment, switchover of the operation level and switchover of the gate resistance value Rgoff are performed at a control interval that is the fundamental cycle of output current of the power conversion device. In FIG. 8, A1 shows U-phase current Iu of the inverter circuit 3, and switchover of the operation level and switchover of the gate resistance value Rgoff are performed in a peak region of the U-phase current Iu.

In FIG. 8, switchover of the operation level and switchover of the gate resistance value Rgoff are described for the U-phase current Iu of the power conversion device, but the same applies to V-phase current Iv and W-phase current Iw of the power conversion device and the description thereof is omitted.

In FIG. 8, A2 shows a graph for explaining switchover between 3-level operation and 2-level operation.

In A2 in FIG. 8 a level switchover threshold for switchover from 3-level operation to 2-level operation is denoted by Lvth3-2, and a level switchover threshold for switchover from 2-level operation to 3-level operation is denoted by Lvth2-3.

As shown in A2 in FIG. 8, a current command value (effective value) Iu(rms)* for the power conversion device is provided, and if 3-level operation is being performed at present, whether to operate the power conversion device in 2-level operation or 3-level operation from the present 3-level operation is determined through comparison between the current command value Iu(rms)* and a predetermined level switchover threshold Lvth3-2. If 2-level operation is being performed at present, whether to operate the power conversion device in 3-level operation or 2-level operation from the present 2-level operation is determined through comparison between the current command value Iu(rms)* and a predetermined level switchover threshold Lvth2-3.

In the example of A2 in FIG. 8, a case where 3-level operation is being performed at present and the power conversion device is switched from 3-level operation to 2-level operation on the basis of comparison between the current command value Iu(rms)* and the level switchover threshold Lvth-2, is shown.

As shown in A2 in FIG. 8, when the current command value Iu(rms)* crosses the level switchover threshold Lvth3-2, it is determined that the operation is to be changed from 3-level operation to 2-level operation (an upward arrow drawn by a solid line D represents switchover from 3-level operation to 2-level operation, and at the solid line D, Low indicates 3-level operation and High indicates 2-level operation).

Then, when it is determined that the operation is to be changed from 3-level operation to 2-level operation, first, the gate resistance value for turn-off (in FIG. 8, gate resistance value Rgoff16) which has been used in 3-level operation and is comparatively small, is changed to a greatest value (in FIG. 8, gate resistance value Rgoff1) in a settable range, as shown in A4 in FIG. 8. Specifically, in the gate resistance switchover circuit 10 shown in FIG. 2, the gate resistance value for turn-off is changed from the gate resistance value Rgoff16 realized by all the switches SW2 to SW5 being turned on to the gate resistance value Rgoff1 realized by all the switches SW2 to SW5 being turned off. Here, Rgoff1>>Rgoff16 is satisfied.

Next, after the gate resistance value Rgoff for turn-off is changed to the greatest value (in FIG. 8, gate resistance value Rgoff1), reduction in the slope of gate voltage when the switching element is turned off, decrease in the gate current amount, or reduction in surge voltage is monitored, whereby it is confirmed that the gate resistance value Rgoff for turn-off has actually changed to a great value.

Next, after change corresponding to a result of change of the gate resistance value Rgoff for turn-off of the switching element to the greatest value (change such as reduction in the slope of gate voltage) is confirmed, the operation level of the power conversion device is changed from 3-level operation to 2-level operation, through a period E, as shown in A3 in FIG. 8.

In this way, the gate resistance value Rgoff for turn-off is changed from a small value to a great value before switchover of the operation level from 3-level operation to 2-level operation.

That is, in a state in which, in 3-level operation, the gate resistance value for turn-off is selected to be a comparatively small value (Rgoff16 in FIG. 8) adjusted so that maximum surge voltage substantially becomes the allowable surge voltage, if the operation is changed to 2-level operation, voltage applied across the switching element of the inverter circuit 3 is doubled, so that the allowable surge voltage for the voltage of the switching element is exceeded (indicated by a dotted line H in A5 in FIG. 8), thus causing a risk that the switching element fails. However, by performing control as described in the present embodiment, it is possible to prevent failure of the switching element and minimize loss.

Here, a thin solid line in AS in FIG. 8 indicates voltage (instantaneous value) Va of the switching element 3a, and a thick solid line indicates a voltage maximum value (arm voltage maximum value) Vmaxa which is a held maximum value of the voltage Va of the switching element 3a.

Similarly, a thin solid line in A6 in FIG. 8 indicates voltage (instantaneous value) Vb of the switching element 3b, and a thick solid line indicates a voltage maximum value (arm voltage maximum value) Vmaxb which is a held maximum value of voltage Vb of the switching element 3b.

The arm voltage maximum values Vmaxa, Vmaxb can be obtained by such a configuration that maximum values of the voltages (instantaneous values) Va, Vb are held using software in the control circuit 8, or such a configuration that a capacitor (hardware) is used and charged with maximum voltages of the voltages (instantaneous values) Va, Vb, for example. The arm voltage maximum values Vmaxa, Vmaxb are reset to zero at the same time as operation level switchover.

A7 in FIG. 8 shows ON/OFF operations of the switching elements 3a, 3b, 4a, 4b.

In the description in FIG. 8, determination for switchover of the operation level is performed on the basis of the current command value Iu(rms)*. However, instead of the current command value Iu(rms)*, a determination criterion calculated from a table prepared in advance in association with the rotational speed or required torque of the motor may be used. Further, determination may be performed on the basis of a loss calculation result in 2-level operation and 3-level operation in accordance with the rotational speed of torque of the motor.

In the present embodiment, in 3-level operation, whether or not to perform switchover of the operation level is determined through comparison between the current command value Iu(rms)* and the level switchover threshold Lvth3-2, and in 2-level operation, whether or not to perform switchover of the operation level is determined through comparison between Iu(rms)* and the level switchover threshold Lvth2-3. In this case, these level switchover thresholds satisfy (level switchover threshold Lvth3-2)>(level switchover threshold Lvth2-3). Thus, hysteresis is provided between the level switchover thresholds Lvth3-2 and Lvth2-3 in accordance with the present operation level, whereby frequent operation level change can be avoided.

In the above description, in order to reduce the volume (size) of the power conversion device as far as possible in accordance with the current value, current smaller than the level switchover threshold is set in 3-level operation, and current not smaller than the level switchover threshold is set in 2-level operation. However, in a case of not considering the volume (size) of the power conversion device, current smaller than the level switchover threshold may be set in 2-level operation and current not smaller than the level switchover threshold may be set in 3-level operation. Thus, surge voltage in a current peak region of a sinewave where surge voltage becomes great can be suppressed, whereby the gate resistance value for turn-off in a large current region can be reduced, leading to further loss reduction.

### [Specific Control Flowchart in Power Conversion Device]

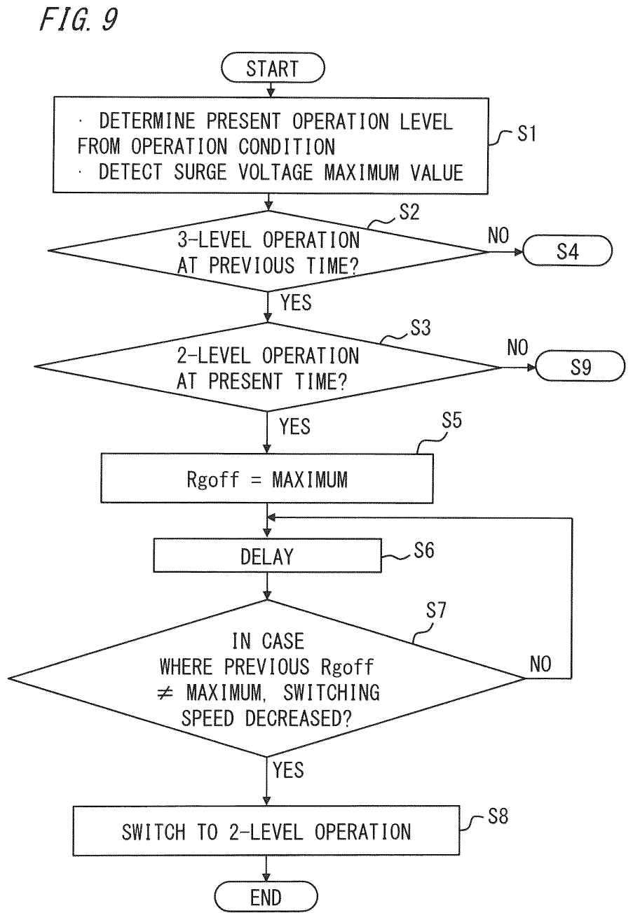

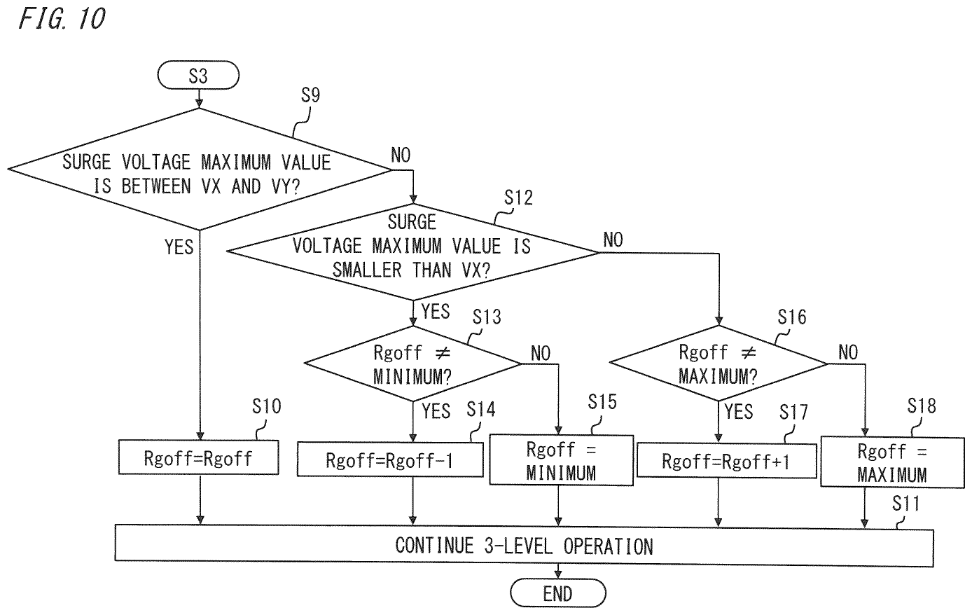

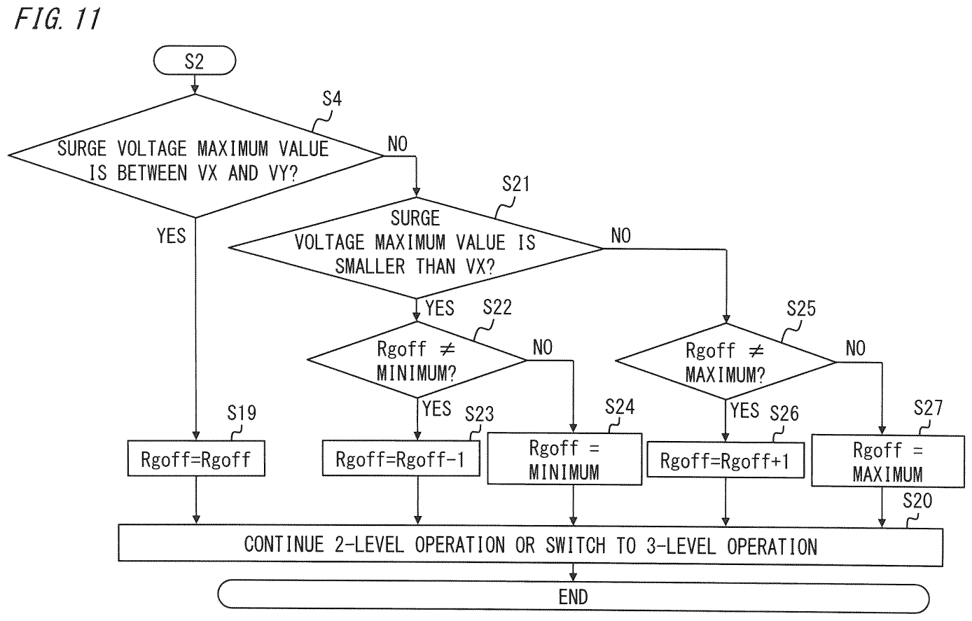

FIG. 9, FIG. 10, and FIG. 11 show specific examples of control flowcharts in the power conversion device of the present embodiment, and the control flowcharts will be described below. Here, control of the power conversion device capable of 2-stage switchover between 2-level operation and 3-level operation will be described as an example, and the control flowcharts are performed in every fundamental cycle of AC output of the power conversion device.

In FIG. 9, the control flow is performed from START. In step S1, whether the present operation level is 2-level operation or 3-level operation is determined on the basis of the operation condition described above. Further, in step S1, a surge voltage maximum value in the fundamental cycle of AC output is detected. That is, the arm voltage maximum values Vmaxa, Vmaxb indicated by the thick solid lines in A5 and A6 in FIG. 8 are detected.

In step S2, in order to confirm whether or not the timing of changing the operation level from 3-level operation to 2-level operation has come, first, whether or not the previous operation level was 3-level operation is determined. If the previous operation level was 3-level operation (YES), step S3 is executed, and if the previous operation level was 2-level operation (NO), step S4 in FIG. 11 is executed.

In step S4 in FIG. 11, since the previous operation level was 2-level operation, there is no such risk that surge voltage when the operation level is changed exceeds the allowable surge upper limit voltage VY, and optimization control for the gate resistance value for turn-off is continued. That is, in step S4, whether or not the surge voltage maximum value is within the range between the allowable surge lower limit voltage VX and the allowable surge upper limit voltage VY is confirmed. If the surge voltage maximum value is within the range between the allowable surge lower limit voltage VX and the allowable surge upper limit voltage VY (YES), an optimum gate resistance value Rgoff for turn-off has been selected, and therefore the present gate resistance value Rgoff for turn-off is kept (step S19). Then, operation is performed at the present operation level determined in step S1 (step S20), and thus the present cycle ends.

On the other hand, in step S4, if the surge voltage maximum value is not within the range between the allowable surge lower limit voltage VX and the allowable surge upper limit voltage VY (NO), whether the surge voltage maximum value is smaller than the allowable surge lower limit voltage VX or greater than the allowable surge upper limit voltage VY is determined. That is, in step S21, whether or not the surge voltage maximum value is smaller than the allowable surge lower limit voltage VX is confirmed. If the surge voltage maximum value is smaller than the allowable surge lower limit voltage VX (YES), it is determined that there is room for further loss reduction, and the gate resistance value Rgoff for turn-off is reduced. Here, if the gate resistance value Rgoff for turn-off has already been set at the minimum value, the gate resistance value Rgoff for turn-off cannot be minimized any more. Therefore, in step S22, whether or not the present gate resistance value Rgoff for turn-off has been set at the minimum value is confirmed. If the gate resistance value Rgoff for turn-off is not minimum in step S22 (YES), the gate resistance value Rgoff for turn-off is 1-stage reduced (step S23), and operation is performed at the present operation level determined in step S1 (step S20). Thus, the present cycle ends.

On the other hand, if the gate resistance value Rgoff for turn-off is the minimum value in step S22 (NO), the gate resistance value Rgoff for turn-off cannot be reduced any more. Therefore, the gate resistance value Rgoff for turn-off is set at the minimum value which is the same as the present value (step S24), and operation is performed at the present operation level determined in step S1 (step S20). Thus, the present cycle ends.

In a case of NO in step S21, the surge voltage maximum value is greater than the allowable surge upper limit voltage VY, and thus there is a risk of failure of the switching element. Therefore, the gate resistance value Rgoff for turn-off is set to be great. Here, if the gate resistance value Rgoff for turn-off has already been set at the maximum value, the gate resistance value Rgoff for turn-off cannot be maximized any more. Therefore, in step S25, whether or not the present gate resistance value Rgoff for turn-off has been set at the maximum value is confirmed. If the gate resistance value Rgoff for turn-off is not maximum in step S25 (YES), the gate resistance value Rgoff for turn-off is 1-stage increased (step S26), and operation is performed at the present operation level determined in step S1 (step S20). Thus, the present cycle ends.

On the other hand, if the gate resistance value Rgoff for turn-off is maximum in step S25 (NO), the gate resistance value Rgoff for turn-off cannot be increased any more. Therefore, the gate resistance value Rgoff for turn-off is set at the maximum value which is the same as the present value (step S27), and operation is performed at the present operation level determined in step S1 (step S20). Thus, the present cycle ends. At this time, the gate resistance value Rgoff for turn-off has already been the maximum value and the allowable surge upper limit voltage VY is exceeded. Therefore, in order to prevent failure of the switching element, a measure such as transmitting the present state to a host system or limiting output power (current) may be performed.

Here, returning to FIG. 9, in step S3, since the previous operation level was 3-level operation (step S2), it is necessary to confirm whether or not the present operation level is 2-level operation, in order to confirm whether or not the timing of changing from 3-level operation to 2-level operation has come. That is, if the present operation level is 2-level operation in step S3 (YES), step S5 is executed, and if the present operation level is 3-level operation (NO), step S9 in FIG. 10 is executed.

In step S9 in FIG. 10, since both of the previous operation level and the present operation level are 3-level operation, there is no risk of failure of the switching element due to surge voltage in operation level switchover, and optimization control for the gate resistance value for turn-off is continued. That is, in step S9, whether or not the surge voltage maximum value is within the range between the allowable surge lower limit voltage VX and the allowable surge upper limit voltage VY is confirmed. If the surge voltage maximum value is within the range between the allowable surge lower limit voltage VX and the allowable surge upper limit voltage VY (YES), an optimum gate resistance value Rgoff for turn-off has been selected, and therefore the present gate resistance value Rgoff for turn-off is kept (step S10). Then, 3-level operation is performed also at this time as determined in step S1 (step S11), and thus the present cycle ends.

On the other hand, if the surge voltage maximum value is not within the range between the allowable surge lower limit voltage VX and the allowable surge upper limit voltage VY in step S9 (NO), whether the surge voltage maximum value is smaller than the allowable surge lower limit voltage VX or greater than the allowable surge upper limit voltage VY is determined in step S12. That is, in step S12, whether or not the surge voltage maximum value is smaller than the allowable surge lower limit voltage VX is confirmed. If the Surge voltage maximum value is smaller than the allowable surge lower limit voltage VX (YES), it is determined that there is room for further loss reduction, and the gate resistance value Rgoff for turn-off is reduced. Here, if the gate resistance value Rgoff for turn-off has already been set at the minimum value, the gate resistance value Rgoff for turn-off cannot be minimized any more. Therefore, in step S13, whether or not the present gate resistance value Rgoff for turn-off has not been set at the minimum value is confirmed.

If the gate resistance value Rgoff for turn-off is not minimum in step S13 (YES), the gate resistance value Rgoff for turn-off is 1-stage reduced (step S14). Then, 3-level operation is continued (step S11), and thus the present cycle ends.

On the other hand, if the gate resistance value Rgoff for turn-off is the minimum value in step S13 (NO), the gate resistance value Rgoff cannot be reduced any more.

Therefore, the gate resistance value Rgoff is set at the minimum value which is the same as the present value (step S15), and 3-level operation is continued (step S11). Thus, the present cycle ends.

In step S12, if the surge voltage maximum value is greater than the allowable surge upper limit voltage VY (NO), there is a risk of failure of the switching element, and therefore the gate resistance value Rgoff for turn-off is set to be great. Here, if the gate resistance value Rgoff for turn-off has already been set at the maximum value, the gate resistance value Rgoff for turn-off cannot be maximized any more. Therefore, in step S16, whether or not the present gate resistance value Rgoff for turn-off has not been set at the maximum value is confirmed. If the gate resistance value Rgoff for turn-off is not the maximum value in step S16 (YES), the gate resistance value Rgoff for turn-off is 1-stage increased (step S17). Then, 3-level operation is continued (step S11), and thus the present cycle end.

On the other hand, if the gate resistance value Rgoff for turn-off is the maximum value in step S16 (NO), the gate resistance value Rgoff for turn-off cannot be increased any more. Therefore, the gate resistance value Rgoff for turn-off is set at the maximum value which is the same as the present value (step S18). Then, operation is performed at the present operation level determined in step S1 (step S11), and thus the present cycle ends. At this time, the gate resistance value Rgoff for turn-off has already been the maximum value and the allowable surge upper limit voltage VY is exceeded. Therefore, in order to prevent failure of the switching element, a measure such as transmitting the present state to a host system or limiting output power (current) may be performed.

Returning to FIG. 9, in step SS, since the previous operation level was 3-level operation (YES in step S2) and the present operation level is 2-level operation (YES in step S3), if 2-level operation is performed using the gate resistance value Rgoff optimally adjusted in 3-level operation, there is a risk that excessive surge voltage occurs across the switching element. Therefore, in step S5, the gate resistance value Rgoff for turn-off is set to be the maximum value.

Here, if switchover to 2-level operation is performed at the same time as change of the gate resistance value Rgoff for turn-off, switching operation is performed in 2-level operation before switchover of the gate resistance value Rgoff is completed. Thus, excessive surge voltage occurs at the switching element, so that there is a risk that the switching element fails.

Therefore, switchover to 2-level operation is not performed until switchover of the gate resistance value Rgoff is completed.

In step S6, in consideration of the switching speed of the switches SW of the gate resistance switchover circuit 10, the process waits until a period (e.g., 1 μs) sufficient for completion of switching elapses, and then proceeds to step S7.

In step S7, the switching speed in previous switching-off, and the switching speed in present switching-off after the gate resistance value Rgoff is maximized, are compared, to confirm whether or not the switching speed is decreased by a certain value or more.

If the switching speed is decreased by a certain value or more in step S7 (YES), it is determined that change of the gate resistance value Rgoff to the maximum value is completed. Then, the process proceeds to step S8, to execute switchover to 2-level operation.

On the other hand, if the switching speed has not been decreased by a certain value or more in step S7 (NO), it is determined that the gate resistance value Rgoff has not been changed to the maximum value yet, and therefore certain delay in step S6 and then the determination in step S7 are continued until the gate resistance value Rgoff becomes the maximum value.

Here, if the gate resistance value Rgoff for turn-off has already been maximum in the previous switching, the gate resistance value Rgoff cannot be increased any more. Therefore, comparison of the switching speeds in switching-off is not performed and the process proceeds to step S8, to perform switchover to 2-level operation.

In step S7, completion of switchover of the gate resistance value Rgoff for turn-off is determined on the basis of change in the switching speed in switching-off. However, another method may be employed as long as it can be confirmed that the gate resistance value Rgoff has been completely switched. For example, the complete switchover may be determined on the basis of the fact that, after a change instruction for the switching speed, the slope of gate voltage applied to the gate terminal of the switching element has changed by a certain value or more, or gate current of the switching element has changed by a certain value or more, or the maximum value of surge voltage generated across the switching element or across a plurality of capacitors has changed by a certain value more.

By performing switchover of the operation level and switchover of the gate resistance value for turn-off through the above control flow, it is possible to perform control for minimizing loss within a range where the maximum surge voltage does not exceed the allowable surge voltage.

In the above description, the method in which the control circuit 8 performs switchover between 2-level operation and 3-level operation and also performs switchover of the gate resistance value for turn-off, so as to minimize loss in the power conversion device, has been described. However, switchover between 2-level operation and 3-level operation and switchover of the gate resistance value for turn-off may be performed so as to minimize total loss including loss in the power conversion device and loss in the motor.

In addition to switchover between 2-level operation and 3-level operation and switchover of the gate resistance value for turn-off, control for changing the carrier frequency for controlling operation of the inverter circuit may be performed. As described above, in 3-level operation, current distortion is reduced, so that motor iron loss is reduced. If the carrier frequency is decreased, current distortion increases and therefore motor iron loss increases, but loss in the power conversion device is reduced. Thus, depending on the condition, total loss can be reduced. Therefore, in a case where the rotational speed command is the same, the carrier frequency in 3-level operation may be set to be not greater than the carrier frequency in 2-level operation. That is, where the carrier frequency in 2-level operation is denoted by fx_2lv and the carrier frequency in 3-level operation is denoted by fx_3lv, the carrier frequencies are set so as to satisfy fx_2lv≥fx_3lv.

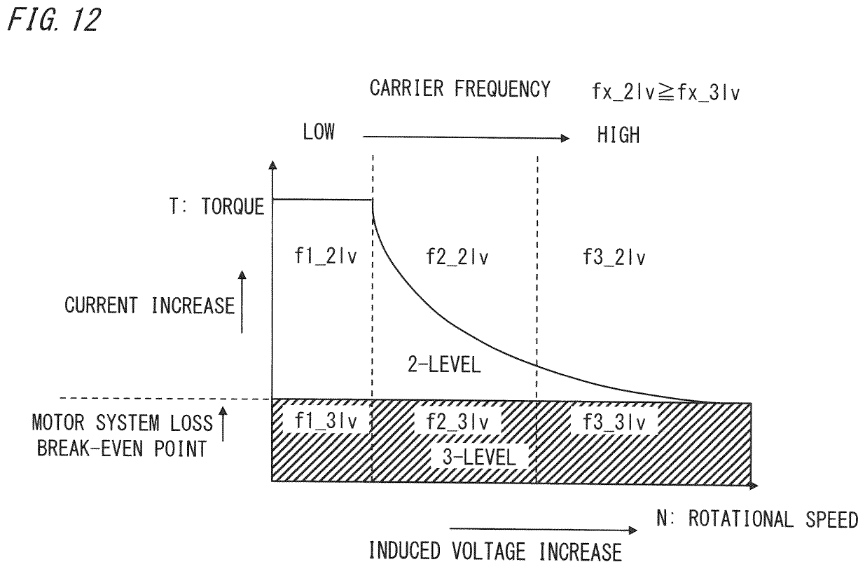

FIG. 12 is a graph in which 2-level operation and 3-level operation of the power conversion device (inverter circuit), and the carrier frequency, are schematically mapped on the rotational speed and torque characteristics of the motor. In a case where the rotational speed command of the motor is the same, if the torque command (or current command) is not smaller than a predetermined threshold, the control circuit 8 performs switchover to 2-level operation, and if the torque command (or current command) is smaller than the predetermined threshold, the control circuit 8 performs switchover to 3-level operation. Here, the predetermined threshold is a threshold set in advance on the basis of calculation results of the loss amount and the volume amount in the power conversion device as described above, for example. In the example shown in FIG. 12, one threshold is provided. However, a plurality of thresholds may be provided for hysteresis control, so as to stabilize operation. For example, as a threshold for performing switchover between 2-level operation and 3-level operation in accordance with the torque command, different thresholds are provided for a case of increasing the torque command and a case of decreasing the torque command. In addition, if the threshold in a case of increase is set to be greater than the threshold in a case of decrease, it is possible to prevent switchover from being performed between 2-level operation and 3-level operation unnecessarily, and thus operation is stabilized.

In the operation map shown in FIG. 12, the carrier frequency is also changed in accordance with the rotational speed command of the motor. Regarding setting of the carrier frequency, in 3-level operation, current distortion of the motor is reduced, and therefore harmonic iron loss is reduced as compared to 2-level operation. Since switching loss and the switching frequency in the inverter circuit are in a proportional relationship, reducing the frequency enables usage with inverter loss reduced, though this has a trade-off relationship with high-frequency iron loss of the motor. Thus, the carrier frequency is a contradictory parameter between the inverter circuit and the motor, and it is necessary to make setting so as to minimize total loss of the inverter circuit and the motor while ensuring controllability, Normally, in a region in which the rotational speed is high, harmonic iron loss of the motor is dominant in loss in the motor system. Therefore, the carrier frequency may be increased as the rotational speed increases. Thus, in the example shown in FIG. 10, the carrier frequency is changed at three stages in accordance with the rotational speed, and f1_3lv<f2_3lv<f3_3lv is satisfied.

Not only the torque command of the rotational speed command but also another parameter may be used to calculate losses of the inverter circuit and the motor in 2-level operation and 3-level operation. For example, in addition to the torque command or the rotational speed command, the voltage of the DC voltage source and the temperature of the power conversion device may be used, an operation table associated with at least one parameter of the voltage of the DC voltage source and the temperature of the power conversion device may be stored, and losses of the power conversion device and the motor may be calculated on the basis of the operation table.

### [Configuration of Other Power Conversion Device]

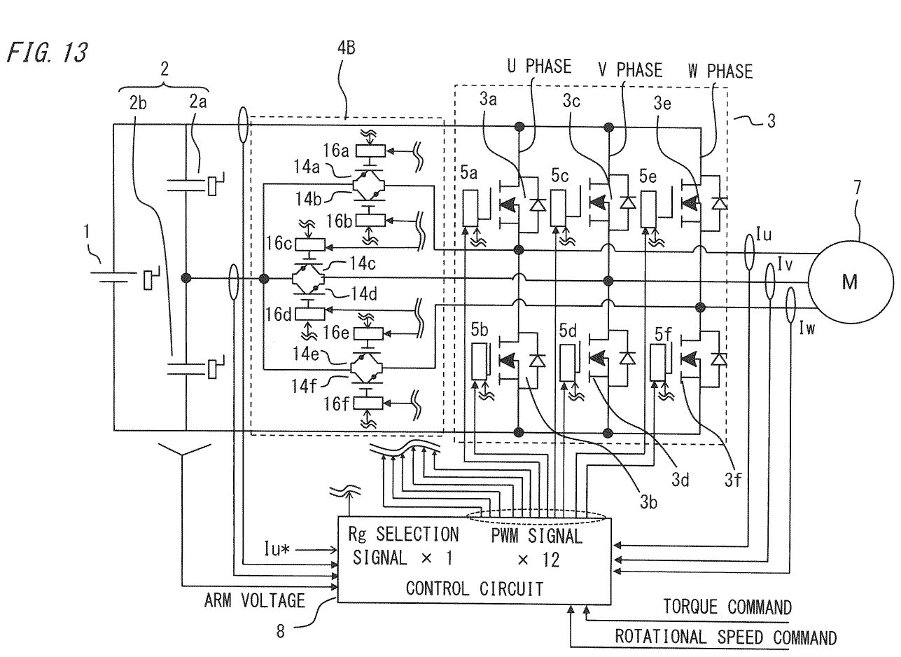

In the power conversion device shown in FIG. 1, the switch circuit 4 provided for performing 3-level operation is formed using a metal oxide semiconductor field effect transistor (MOSFET) having an antiparallel diode between the source and the drain. However, as shown in FIG. 13, a switch circuit 4B formed using an insulated gate bipolar transistor (IGBT) of a reverse blocking type may be adopted.

The switch circuit 4B of the power conversion device shown in FIG. 13 includes switching elements 14a, 14b, 14c, 14d, 14e, 14f which are IGBTs of a reverse blocking type. The switching element 14a and the switching element 14b, the switching element 14c and the switching element 14d, and the switching element 14e and the switching element 14f, are connected in parallel in opposite directions. One end of the switch circuit 4B is connected to the first connection point of the capacitor series circuit 2, and other ends are connected to the second, third, and fourth connection points. Here, 16a, 16b, 16c, 16d, 16e, and 16f denote gate input units for the switching elements 14a, 14b, 14c, 14d, 14e, 14f. The other configurations are the same as in the power conversion device shown in FIG. 1.

The power conversion device configured as shown in FIG. 13 can also provide the same operations and effects as in the power conversion device shown in FIG. 1.

### Effects of Embodiment 1

As described above, according to embodiment 1,
the power conversion device includes:
a capacitor series circuit including a plurality of capacitors connected in series, and having both ends connected to both ends of a DC voltage source;
an inverter circuit in which a plurality of legs each including a plurality of switching elements connected in series are connected in parallel, and of which DO input ends are connected to both ends of the capacitor series circuit and AC output ends are connected to a load;
a switch circuit including a plurality of switching elements, and having one end connected to a connection point between the plurality of capacitors, and other ends connected to a plurality of connection points between the switching elements of the inverter circuit; and
a control circuit which controls the inverter circuit and the switch circuit, wherein
the inverter circuit is capable of performing 2-level operation by turning off the switching elements included in the switch circuit, and capable of performing 3-level operation by turning on/off the switching elements included in the switch circuit, and
in a case of performing switchover of an operation level between the 2-level operation and the 3-level operation, the control circuit changes switching speeds of the switching elements of the inverter circuit and the switch circuit.

Thus, it is possible to provide a power conversion device that has no risk of failure of switching elements even in switchover of the operation level.

In a case of changing from the 3-level operation to the 2-level operation, the control circuit decreases the switching speeds of the switching elements. Thus, surge voltage can be kept within the allowable range, so that there is no risk of failure of the switching elements.

Before performing switchover of the operation level between the 3-level operation and the 2-level operation, the control circuit changes the switching speeds of the switching elements. Thus, surge voltage can be assuredly kept within the allowable range, so that there is no risk of failure of the switching elements.

After performing a change instruction for the switching speeds of the switching elements, the control circuit waits during a certain period and then performs switchover of the operation level between the 3-level operation and the 2-level operation. Thus, surge voltage can be assuredly kept within the allowable range, so that there is no risk of failure of the switching elements.

After performing a change instruction for the switching speeds of the switching elements, the control circuit confirms change processing for the switching speeds on the basis of changes in the switching speeds of the switching elements. Thus, it is possible to assuredly keep surge voltage within the allowable range.

After performing a change instruction for the switching speeds of the switching elements, the control circuit confirms change processing for the switching speeds on the basis of a fact that a slope of gate voltage applied to a gate terminal of each switching element has changed.

Thus, it is possible to assuredly keep surge voltage within the allowable range.

After performing a change instruction for the switching speeds of the switching elements, the control circuit confirms change processing for the switching speeds on the basis of a fact that gate current of each switching 15. element has changed. Thus, it is possible to assuredly keep surge voltage within the allowable range.

After performing a change instruction for the switching speeds of the switching elements, the control circuit confirms change processing for the switching speeds on the basis of a fact that surge voltage generated across each switching element or across the capacitor series circuit has changed. Thus, it is possible to assuredly keep surge voltage within the allowable range.

A level switchover threshold for changing from the 2-level operation to the 3-level operation, and a level switchover threshold for changing from the 3-level operation to the 2-level operation, are different from each other so as to provide hysteresis. Thus, it is possible to avoid frequent operation level change.

The control circuit changes the switching speeds of the switching elements on the basis of a detected value of surge voltage generated across each switching element or across the capacitor series circuit. Thus, it is possible to assuredly keep surge voltage within the allowable range.

The control circuit changes the switching speeds of the switching elements so that a maximum value of the detected value of the surge voltage generated across each switching element or across the capacitor series circuit is kept within a target allowable voltage range. Thus, it is possible to assuredly keep surge voltage within the allowable range.

The control circuit changes the switching speeds on the basis of the detected values of the surge voltage obtained a plurality of consecutive times. Thus, it is possible to assuredly keep surge voltage within the allowable range.

The control circuit performs switchover between the 2-level operation and the 3-level operation on the basis of comparison between an AC output current value of the power conversion device and a predetermined current threshold. Thus, it is possible to appropriately perform switchover of the operation level.

The control circuit performs switchover of the operation level and change of the switching speeds, in every fundamental cycle of AC output current of the power conversion device. Thus, it is possible to appropriately perform switchover of the operation level and change of the switching speeds.

A level switchover threshold for performing switchover between the 2-level operation and the 3-level operation is determined in accordance with a volume of the switching elements of the switch circuit. Thus, it is possible to appropriately perform switchover of the operation level.

A motor is connected as the load, and the control circuit determines switchover of the operation level, and the switching speeds, from a table prepared in advance or a calculation result, on the basis of command information for the motor and the power conversion device, and detection information about the motor and the power conversion device. Thus, it is possible to appropriately perform switchover of the operation level and change of the switching speeds.

Here, the “command information for the motor and the power conversion device” refers to information such as “a torque command or a rotational speed command for the motor and a phase current command (Iu(rms)*, Iu*, etc. ) for the power conversion device”. The “detection information about the motor and the power conversion device” refers to information such as “the rotational speed of the motor, phase current (Iu, etc.) of the power conversion device, a switching modulation factor of the switching element, gate voltage of the switching element, bus voltage of the power conversion device, surge voltage, and temperature”.

The control circuit realizes change of the switching speeds of the switching elements by changing gate resistance values at a time of turning off the switching elements. Thus, change of the switching speeds of the switching elements is appropriately performed.

### Embodiment 2

Next, a power conversion device according to embodiment 2 will be described. A circuit block diagram of the power conversion device according to embodiment 2 is the same as the circuit block diagrams of the power conversion devices shown in FIG. 1, FIG. 13, etc., in embodiment 1. However, in the present embodiment 2, control operation by the control circuit of the power conversion device is different from that in embodiment 1.

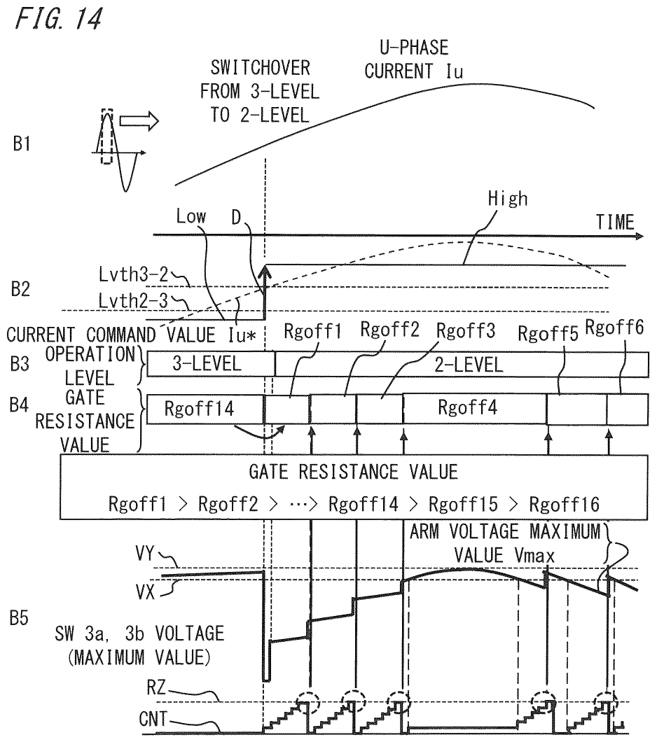

FIG. 14 shows operation of the control circuit of the power conversion device according to the present embodiment 2. A difference from embodiment 1 will be described below, through comparison with control operation (FIG. 8) in embodiment 1. Matters that are not particularly described below are the same as in embodiment 1.

In embodiment 1, switchover of the operation level and switchover of the gate resistance value for turn-off are performed in every fundamental cycle of AC output of the power conversion device, whereas in embodiment 2, switchover of the operation level and switchover of the gate resistance value for turn-off are performed at a time interval shorter than the fundamental cycle of AC output of the power conversion device. That is, in embodiment 1, determination for the operation level is performed through comparison between the AC output current command value (effective value) Iu(rms)* and the level switchover threshold, whereas in embodiment 2, the determination is performed through comparison between an AC output current command value (instantaneous value) Iu* and the level switchover thresholds Lvth3-2, Lvth2-3, as shown in B1 and B2 in FIG. 14.

The determination may be performed through comparison between a detected current value Iu (the average of a plurality of successive detected values) and the level switchover threshold, instead of comparison between the AC output current command value (instantaneous value) Iu* and the level switchover threshold. The detected current value Iu (the average of a plurality of successive detected values) may be obtained by acquiring a detected value of current (e.g., U-phase current Iu in FIG. 1) flowing through the switching element, storing the detected value for each acquisition cycle, and then averaging the latest ten stored values, for example.

Here, regarding selection of the operation level, in embodiment 1, in a case where the current command value (effective value) Iu(rms)* of AC output is greater than the level switchover threshold, 2-level operation is performed over the entire region of AC output (sinewave). However, in embodiment 2, since the determination is performed through comparison between the current command value (instantaneous value) Iu* of AC output and the level switchover threshold, 3-level operation is performed in a low-current region of AC output (sinewave), and thus further loss reduction in the power conversion device is achieved.

In addition, regarding selection of the gate resistance value for turn-off, in embodiment 1, determination is performed so as to satisfy surge voltage constraints at the maximum current value of AC output (sinewave). Therefore there is a margin for surge voltage in a current region other than the vicinity of the maximum current value, that is, there is room for further loss reduction. In contrast, in embodiment 2, the gate resistance value for turn-off is changed at each time so as to satisfy surge voltage constraints over the entire region of AC output (sinewave). Therefore, there is no surge margin also in a current region other than the vicinity of the maximum current value, so that further loss reduction is achieved. Here, satisfying the surge voltage constraints means that surge voltage does not exceed the module withstand voltage of the switching elements.

With reference to FIG. 14, operation for realizing switchover of the operation level and switchover of the gate resistance value for turn-off according to embodiment 2 will be described.

As shown in FIG. 14, in a case where 3-level operation is being performed at present, whether or not to perform 2-level operation or 3-level operation is determined through comparison between the current command value (instantaneous value) Iu* of the power conversion device and the predetermined level switchover threshold Lvth3-2. That is, as shown in B2 in FIG. 14, when the current command value (instantaneous value) Iu* crosses the level switchover threshold Lvth3-2, it is determined that the operation is to be changed from 3-level operation to 2-level operation (an upward arrow drawn by a solid line D represents switchover from 3-level operation to 2-level operation, and at the solid line D, Low indicates 3-level operation and High indicates 2-level operation). Then, when it is determined that the operation is to be changed from 3-level operation to 2-level operation, first, the gate resistance value for turn-off (gate resistance value Rgoff14) which has been used in 3-level operation and is comparatively small, is changed to a greatest value (in FIG. 14, gate resistance value Rgoff1) in a settable range, as shown in B4 in FIG. 14.

Next, after the gate resistance value for turn-off is changed to the greatest value (in FIG. 14, gate resistance value Rgoff1), reduction in the slope of the gate voltage when the switching element is turned off, decrease in the gate current amount, or reduction in surge voltage is monitored, whereby it is confirmed that the gate resistance value Rgoff for turn-off has actually changed to a great value.

Next, after change corresponding to a result of change of the gate resistance value Rgoff for turn-off of the switching element to the greatest value (change such as reduction in the slope of gate voltage) is confirmed, the operation level is changed from 3-level operation to 2-level operation, as shown in B3 in FIG. 14.

In this way, the gate resistance value Rgoff for turn-off is changed from a small value to a great value before switchover of the operation level from 3-level operation to 2-level operation.

Then, in embodiment 2, regarding maximum surge voltage detection for selection of the gate resistance value for turn-off, determination is performed using successive detected values of surge voltage. That is, as shown in B5 in FIG. 14, in a case where the surge voltage detected value (arm voltage maximum value) Vmax is smaller than the allowable surge voltage VX, a surge margin detection CNT (counter) value is incremented by +1, and then, at each time when the surge margin detection CNT value has reached a predetermined Rgoff switchover threshold RZ, the gate resistance value Rgoff for turn-off is sequentially changed. That is, in FIG. 14, at each time when the surge margin detection CNT value has reached the Rgoff switchover threshold RZ, the gate resistance value is sequentially changed to Rgoff1, Rgoff2, Rgoff3, Rgoff4, Rgoff5, Rgoff6, . . . , for example.

Here, Rgoff1>Rgoff2>Rgoff3>Rgoff4> . . . >Rgoff14>Rgoff15>Rgoff16 is satisfied.

In this way, by changing the gate resistance value Rgoff for turn-off when the surge margin detection CNT value has reached the predetermined Rgoff switchover threshold RZ, the gate resistance value for turn-off can be prevented from being frequently changed, whereby it becomes possible to suppress unstable fluctuation of the gate resistance value.

The other control in embodiment 2 is the same as in embodiment 1 and therefore the description thereof is omitted.

In embodiment 2, on the basis of detection information (phase current, phase current (torque) command value, rotational speed detected value, modulation factor, gate voltage value, surge voltage value, temperature, etc.) of the motor and the power conversion device, a combination of the operation level and the gate resistance for turn-off that minimizes loss while keeping surge voltage within the allowable range may be calculated in every control cycle and may be determined from a table prepared in advance or through loss calculation. In particular, in embodiment 2, since switchover of the operation level and switchover of the gate resistance value for turn-off are performed at a comparatively high speed, a great effect can be obtained for loss reduction.

In embodiment 2, switchover of the operation level and switchover of the gate resistance value for turn-off are performed in, for example, every AC output current detection cycle for controlling AC output current, which is shorter than the fundamental cycle, whereby switchover between 2-level operation and 3-level operation and switchover of the gate resistance value for turn-off can be performed also in the same cycle, and thus it is possible to achieve strong loss reduction while ensuring safety.

### Effects of Embodiment 2

As described above, according to embodiment 2, the same effects as in embodiment 1 can be provided, and in addition, the following effects can be provided.

That is, the control circuit performs switchover of the operation level and change of the switching speeds, at a time interval shorter than a fundamental cycle of AC output current of the power conversion device. Thus, it is possible to perform switchover of the operation level and change of the switching speed more assuredly and appropriately.

### [Hardware Configuration of Control Circuit]

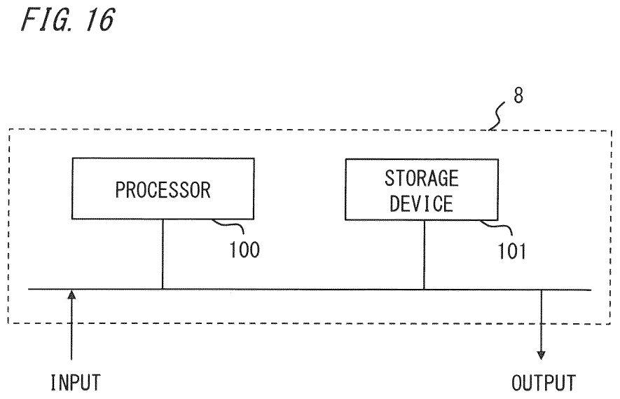

The control circuit 8 in each of embodiments 1 and 2 is composed of a processor 100 and a storage device 101, as shown in a hardware example in FIG. 16. The storage device 101 is provided with a volatile storage device such as a random access memory and a nonvolatile auxiliary storage device such as a flash memory, which are not shown.

Instead of the flash memory, a hard disk may be provided. The processor 100 executes a program inputted from the storage device 101. In this case, the program is inputted from the auxiliary storage device to the processor 100 via the volatile storage device. The processor 100 may output data such as a calculation result to the volatile storage device of the storage device 101 of may store such data into the auxiliary storage device via the volatile storage device.

### Other Embodiments

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure.

For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 DC voltage source
2 capacitor series circuit
2a, 2b capacitor
3 inverter circuit
3a, 3b, 3c, 3d, 3e, 3f switching element (inverter circuit)
4, 4B switch circuit
4a, 4b, 4c, 4d, 4e, 4f switching element (switch circuit)
14a, 14b, 14c, 14d, 14e, 14f switching element (switch circuit)
5a, 5b, 5c, 5d, 5e, 5fgate input unit (inverter circuit)
6a, 6b, 6c, 6d, 6e, 6f gate input unit (switch circuit)
16a, 16b, 16c, 16d, 16e, 16f gate input unit (switch circuit)
7 motor (load)
8 control circuit
9 gate resistance determination unit
10 gate resistance switchover circuit
11 buffer circuit
12 ON power supply
15 OFF power supply

1. A power conversion device comprising:
a capacitor series circuit including a plurality of capacitors connected in series, and having both ends connected to both ends of a DC voltage source;
an inverter circuit in which a plurality of legs each including a plurality of switching elements connected in series are connected in parallel, and of which DC input ends are connected to both ends of the capacitor series circuit and AC output ends are connected to a load;
a switch circuit including a plurality of switching elements, and having one end connected to a connection point between the plurality of capacitors, and other ends connected to a plurality of connection points between the switching elements of the inverter circuit; and
a control circuit which controls the inverter circuit and the switch circuit, wherein
the inverter circuit is capable of performing 2-level operation by turning off the switching elements included in the switch circuit, and capable of performing 3-level operation by turning on/off the switching elements included in the switch circuit, and
in a case of performing switchover of an operation level between the 2-level operation and the 3-level operation, the control circuit changes switching speeds of the switching elements of the inverter circuit and the switch circuit.

2. The power conversion device according to claim 1, wherein
in a case of changing from the 3-level operation to the 2-level operation, the control circuit decreases the switching speeds of the switching elements.

3. The power conversion device according to claim 1, wherein
before performing switchover of the operation level between the 3-level operation and the 2-level operation, the control circuit changes the switching speeds of the switching elements.

4. The power conversion device according to claim 1, wherein
after performing a change instruction for the switching speeds of the switching elements, the control circuit waits during a certain period and then performs switchover of the operation level between the 3-level operation and the 2-level operation.

5. The power conversion device according to claim 1, wherein
after performing a change instruction for the switching speeds of the switching elements, the control circuit confirms change processing for the switching speeds on the basis of changes in the switching speeds of the switching elements.

6. The power conversion device according to claim 1, wherein
after performing a change instruction for the switching speeds of the switching elements, the control circuit confirms change processing for the switching speeds on the basis of a fact that a slope of gate voltage applied to a gate terminal of each switching element has changed.

7. The power conversion device according to claim 1, wherein
after performing a change instruction for the switching speeds of the switching elements, the control circuit confirms change processing for the switching speeds on the basis of a fact that gate current of each switching element has changed.

8. The power conversion device according to claim 1, wherein
after performing a change instruction for the switching speeds of the switching elements, the control circuit confirms change processing for the switching speeds on the basis of a fact that surge voltage generated across each switching element or across the capacitor series circuit has changed.

9. The power conversion device according to claim 1, wherein
a level switchover threshold for changing from the 2-level operation to the 3-level operation, and a level switchover threshold for changing from the 3-level operation to the 2-level operation, are different from each other.

10. The power conversion device according to claim 1, wherein
the control circuit changes the switching speeds of the switching elements on the basis of a detected value of surge voltage generated across each switching element or across the capacitor series circuit.

11. The power conversion device according to claim 10, wherein
the control circuit changes the switching speeds of the switching elements so that a maximum value of the detected value of the surge voltage generated across each switching element or across the capacitor series circuit is kept within a target allowable voltage range.

12. The power conversion device according to claim 10, wherein
the control circuit changes the switching speeds on the basis of the detected values of the surge voltage obtained a plurality of consecutive times.

13. The power conversion device according to claim 1, wherein
the control circuit performs switchover between the 2-level operation and the 3-level operation on the basis of comparison between an AC output current value of the power conversion device and a predetermined current threshold.

14. The power conversion device according to claim 1, wherein
the control circuit performs switchover of the operation level and change of the switching speeds, in every fundamental cycle of AC output current of the power conversion device.

15. The power conversion device according to claim 1, wherein
the control circuit performs switchover of the operation level and change of the switching speeds, at a time interval shorter than a fundamental cycle of AC output current of the power conversion device.

16. The power conversion device according to claim 1, wherein
a level switchover threshold for performing switchover between the 2-level operation and the 3-level operation is determined in accordance with a volume of the switching elements of the switch circuit.

17. The power conversion device according to claim 1, wherein
a motor is connected as the load, and
the control circuit determines switchover of the operation level, and the switching speeds, from a table prepared in advance or a calculation result, on the basis of command information for the motor and the power conversion device, and detection information about the motor and the power conversion device.

18. The power conversion device according to claim 1, wherein
the control circuit realizes change of the switching speeds of the switching elements by changing gate resistance values at a time of turning off the switching elements.

19. The power conversion device according to claim 2, wherein
before performing switchover of the operation level between the 3-level operation and the 2-level operation, the control circuit changes the switching speeds of the switching elements.

20. The power conversion device according to claim 2, wherein
after performing a change instruction for the switching speeds of the switching elements, the control circuit waits during a certain period and then performs switchover of the operation level between the 3-level operation and the 2-level operation.
